(19) United States
(12) Patent Application Publication
(10) Pub. No.: US 2021/0379675 A1
(43) Pub. Date: Dec. 9, 2021

(54) TOOLING FIXTURE

(71) Applicant: Tak Choi LEE, Fo Tan (HK)

(72) Inventor: Tak Choi LEE, Fo Tan (HK)

(21) Appl. No.: 17/341,826

(22) Filed: Jun. 8, 2021

(30) Foreign Application Priority Data
Jun. 8, 2020 (HK) 32020008865.8

(51) Int. Cl. B23B 31/16

(52) U.S. Cl. CPC B23B 31/16054; B23B 31/16079; B23B 31/16075; B23B 31/16062

(57) ABSTRACT

Tooling fixture includes an installation mount, a rail fixed to the installation mount and a pair of movable jaws which can be clamped or loosened relative to each other and are fixed on the rail. A clamping drive structure for clamping the movable jaws is connected to the movable jaws. The clamping drive mechanism includes a screw and a screw nut matched with the screw. The movable jaws are connected with the screw nut respectively. The screw is rotated, and the movable jaws move relatively to clamp or loosen the work piece. By the cooperation of the screw and the nut, the movable jaws slide on the rail to effectively clamp the work piece. In addition, the number of movable jaws can be set on demand so that they are matched with the screw and the screw nut.

### FIELD OF THE INVENTION

The invention involves a fixture for fast clamping multiple workpieces for subsequent machining with a machine tool.

### BACKGROUND OF THE INVENTION

In machine tool, such as CNC machining centers, it is necessary to clamp the workpiece before processing. In order to improve the machining efficiency for some small parts, multiple clamping devices are usually installed on a fixture to realize the clamping of multiple parts. The four-axis turntable can be used to achieve continuous processing of four sides. But now each part can only be installed to the clamping device separately, so the efficiency is low, and the accuracy is really low indeed. There is no tooling fixture which can clamp multiple workpieces at the same time.

### SUMMARY OF THE INVENTION

In view of the aforesaid drawbacks of the prior art, the present invention provides an tooling fixture, which can clamp plenty of the workpieces by setting corresponding number of movable jaws according to the needs and the movable jaws clamp the workpieces driven by the cooperation of the screw and the nut.

Tooling fixture, wherein includes an installation base; a slide rail is fixed to the installation base, at least a pair of movable jaws are clamped or loosened relative to each other and are fixed on the slide rail; a clamping mechanism for clamping the movable jaws is connected to the movable jaws; the clamping mechanism includes a screw and a matched screw nut; the movable jaws are connected with the screw nut respectively; when the screw is rotated, the movable jaws move to clamp or loosen the workpieces.

Furthermore, a free clamping part which sets and moves along the slide rail is provided between each pair of the movable jaws, and the workpiece is clamped between the free clamping part and the movable jaws or two adjacent free clamping parts.

Furthermore, the installation base is provided two or more working surfaces; the slide rail, the movable jaws and the clamping mechanism are set on each working surface; the screw nut of the clamping mechanism is provided with connection supports; the movable jaws on each working surface are fixed to the related connecting support.

Furthermore, the screw nut is rotatably connected with the connecting bracket along the screw rod, in specific, the connecting support is provided with a central hole, and the screw nut is inserted into the central hole.

Furthermore, the screw nut is provided an operation hole for rotating to fine adjust the screw nut.

Furthermore, the connection between the connecting support and the movable jaws is provided with a protrusion and a groove which are matched to fix together.

Furthermore, the central hole is provided with a locking hoop for locking the screw nut and it is formed by cutting a groove on the wall of the central hole; the end of the locking hoop is provided with an expansion screw; the expansion screw stretches the locking hoop to lock the screw nut in the central hole.

Furthermore, the free clamping part is provided an adjustable toothed sheet, the toothed sheet is fixed to the movable jaws by screw.

Furthermore, the installation base is provided with a cap for locking the screw.

The invention has the following advantages: the movable jaws slides on the slide rail and clamps the workpieces by the cooperation of the screw and the nut. It is easy for operation, and the highly accurate matching of the screw and the nut ensure the clamping accuracy and consistency of the movable jaws. Users can set the number of the movable jaws according the number of workpieces by rotating the screw to clamp all the workpieces, so as to improve the efficiency of installation.

### BRIEF DESCRIPTION OF THE DRAWINGS

Below are explanations of the invention combining with drawings.

FIG. 1 is the perspective view of the present invention.

FIG. 2 is the section view of the present invention.

FIG. 3 is the assembly drawing of the connecting support and the nut.

FIG. 4 is the front view of the connecting support.

FIG. 5 is the perspective view of the movable jaw.

In the figures: 1. the installation base, 2. the slide rail, 3. the movable jaw, 4. the screw, 5. the nut, 6. the free clamping part, 7. the connecting support, 8. the central hole, 9. the operation hole, 10. the protrusion, 11. the groove, 12. the locking hoop, 13. the toothed sheet, 14. the cap.

### DESCRIPTION OF THE EMBODIMENTS

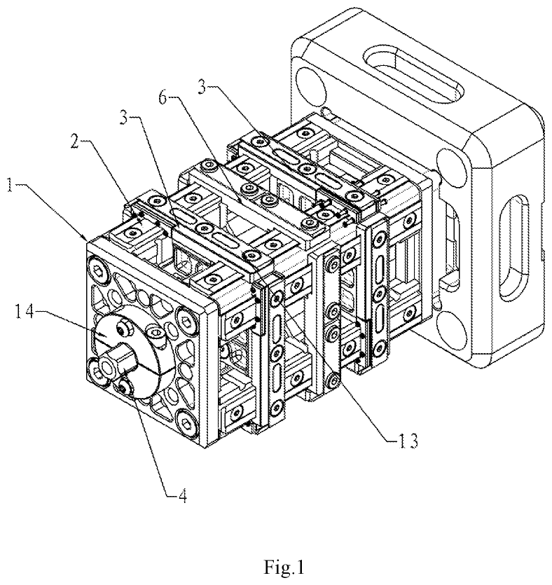

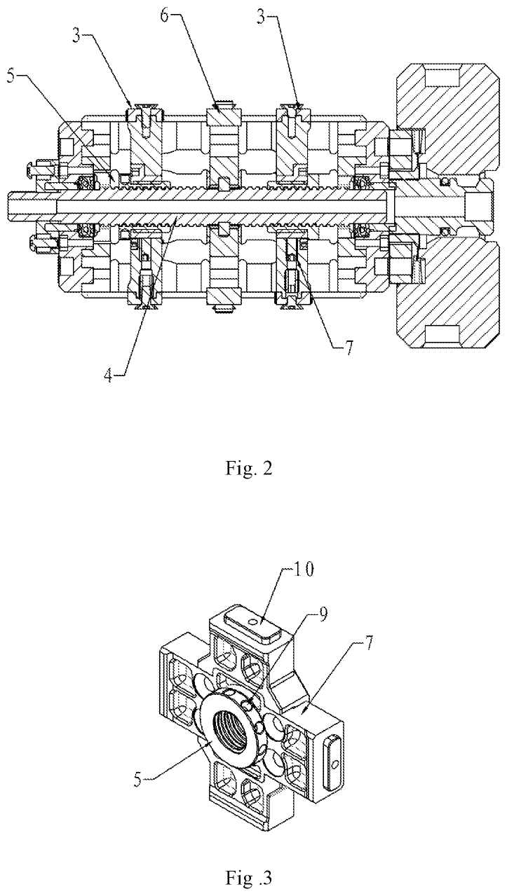

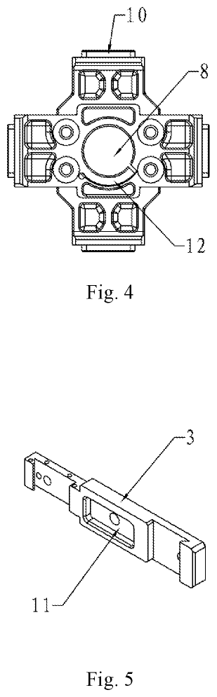

Refer to FIG. 1, the tooling fixture, includes an installation base 1; the slide rail 2 is fixed to the installation base 1, at least a pair of movable jaws 3 are clamped or loosened relative to each other and fixed on the slide rail 2; the clamping mechanism for clamping the movable jaws 3 is connected to the movable jaws 3; the clamping mechanism includes a screw 4 and a matched screw nut 5; the movable jaws 3 are connected with the screw nut 5 respectively; when the screw 4 is rotated, the movable jaws 3 move to clamp or loosen the work piece. The movable jaws slide on the slide rail and clamps the workpiece by the cooperation of the screw and the nut. It is easy for operation, and the highly accurate matching of the screw and the nut ensure the clamping accuracy of the movable jaws. Users can set the number of the movable jaws according the number of workpieces by rotating the screw to clamp all the workpieces, so as to improve the efficiency of installation.

As mentioned, the clamping accuracy between a pair of movable jaws 3 is high, and a pair of movable jaws 3 can be used to clamp workpieces in the same width or different widths according to the needs. There is at least one free clamping part 6 set between a pair of movable jaws 3 and slide on the slide rail 2. The workpieces can be clamped between the free clamping part 6 and the movable jaws 3 or between two adjacent free clamping parts 6. For workpieces with tight dimensional accuracy, in order to simplify and reduce the number of movable jaws 3, multiple free clamping parts 6 can be added between a pair of movable jaws 3 to realize simultaneous clamping and different workpieces can be processed separately.

In order to increase the number of workpieces clamped by the installation base 1, the installation base 1 is provided with two or more working surfaces, and each working surface is provided with slide rails 2, movable jaws 3, and a clamping mechanism. The connecting support 7 is installed on the nut 5 in a clamping mechanism, and each connecting support 7 is respectively connected and fixed with the corresponding movable jaws 3 on the different working surface.

In order to meet the needs of different workpieces clamping, the distance between the connecting supports 7 which is installed on the two movable jaws 3 can be adjusted. After long-term usage, the distance adjustment can also fine tune the accuracy of clamping. So, the nut 5 and the connecting support 7 can be rotated along the screw. Specifically, the connecting support 7 is provided with a central hole 8, and the nut 5 is rotatably inserted into the central hole 8. When the screw 4 is non-rotating and the nut 5 screws along, the distance between the connecting supports 7 is adjusted. In order to facilitate the above adjustment, the nut 5 is provided with the operation hole 9 for fine adjustment of the nut 5. When the fixture is assembled, the operating rod can be inserted into the operating hole 9 and turn the nut 5 to facilitate fine adjustment. It is very convenient and time-saving to operate.

When the fixture is fine adjusted or calibrated, the nut 5 needs to be fixed to prevent rotation between the nut 5 and the connecting support 7 from affecting the accuracy. So, the central hole 8 is also provided with the locking hoop 12 for locking the nut 5. The locking hoop 12 is formed by cutting a groove on the wall of the central hole 8, and an expansion screw is set at the end of the locking hoop 12. When the expansion screw is screwed in, it pushes the locking hoop 12 to reduce the diameter of the central hole 8 to lock the nut 5 inside.

In addition, for the movable jaws 3 being fixed accurately on the connecting support 7, the connecting position between the connecting support 7 and the movable jaws 3 are respectively provided with the protrusion 10 and the groove 11, and the protrusion 10 is matched with the groove 11 to realize the fixed positioning of both of them. Moreover, the workpiece may have dimensional tolerance. In order to make fine adjustments between the movable jaws 3 cooperate and the free clamping part 6 for adapting such dimensional tolerance of the workpieces, the free clamping part is provided an adjustable toothed sheet 13 by screw installation. Since the size of the screw hole of the toothed sheet 13 is slightly larger than that of the screw, so the toothed sheet 13 can be slightly adjusted before it is locked by the screw. When there is dimensional tolerance of the workpiece, it can still be accurately clamped by adjusting the toothed sheet 13.

When the screw 4 is clamped, in order to prevent its rotation from affecting the clamping accuracy, the installation base is provided with the cap 14 which can lock the screw 14 to prevent the machining accuracy from being affected during the machining process.

1. Tooling fixture, wherein includes an installation base; a slide rail is fixed to the installation base, at least a pair of movable jaws are clamped or loosened relative to each other and are fixed on the slide rail; a clamping mechanism for clamping the movable jaws is connected to the movable jaws; the clamping mechanism includes a screw and a matched screw nut; the movable jaws are connected with the screw nut respectively; when the screw is rotated, the movable jaws move to clamp or loosen the work piece.

2. The tooling fixture of claim 1, wherein a free clamping part which sets and moves along the slide rail is provided between each pair of the movable jaws, and the workpiece is clamped between the free clamping part and the movable jaws or two adjacent free clamping parts.

3. The tooling fixture of claim 1, wherein the installation base is provided two or more working surfaces; the slide rail, the movable jaws and the clamping mechanism are set on each working surface; the screw nut of the clamping mechanism is provided with connection supports; the movable jaws on each working surface are fixed to the related connecting support.

4. The tooling fixture of claim 3, wherein the screw nut is rotatably connected with the connecting bracket along the screw rod, in specific, the connecting support is provided with a central hole, and the screw nut is inserted into the central hole.

5. The tooling fixture of claim 4, wherein the screw nut is provided an operation hole for rotating to fine adjust the screw nut.

6. The tooling fixture of claim 4, wherein the connection between the connecting support and the movable jaws is provided with a protrusion and a groove which are matched to fix together.

7. The tooling fixture of claim 4, wherein the central hole is provided with a locking hoop for locking the screw nut and it is formed by cutting a groove on the wall of the central hole; the end of the locking hoop is provided with an expansion screw; the expansion screw stretches the locking hoop to lock the screw nut in the central hole.

8. The tooling fixture of claim 2, wherein the free clamping part is provided an adjustable toothed sheet, the toothed sheet is fixed to the movable jaws by screw.

9. The tooling fixture of claim 1, wherein the installation base is provided with a cap for locking the screw.
